(19) United States
(12) Patent Application Publication
(10) Pub. No.: US 2009/0088530 A1
(43) Pub. Date: Apr. 2, 2009

(54) NOVEL POLYMER COMPOUND AND USES THEREOF

(76) Inventors: Billy Ray BODIFORD, White Oak, TX (US); Nadeem A BOKHARI, Troy, MI (US); Sanjay Patel, Canton, MI (US)

Correspondence Address: CLEMENTS BERNARD MILLER, 1901 ROXBOROUGH ROAD, SUITE 300, CHARLOTTE, NC, 28211, US

(21) Appl. No.: 11/864,309

(22) Filed: Sep. 28, 2007

(51) Int. Cl. C08L 23/06

(52) U.S. Cl. 525/240

(57) ABSTRACT

The present invention is related to novel polyolefin polymer compositions and methods of use thereof, in particular use in passenger and driver airbag cover applications for vehicles, wherein airbag covers are required to perform at extreme temperatures with no failures, brittle or ductile fractures. The polyolefin polymer includes: a first component having at least one polypropylene copolymer or homo propylene polymer present in the range of up to about 70% by weight of the polymer composition; a second component having at least one ethylene/octene copolymer present in the range of up to about 85% by weight of the polymer composition; and optionally, a third component having at least one metallocene elastomer comprising ethylene and a co-monomer. A method of forming an airbag cover from the polyolefin polymer is also described.

### TECHNICAL FIELD

During automotive airbag deployment, airbag covers are required to perform at extreme temperatures with no failures, brittle or ductile fractures. The present invention is related to novel polyolefin polymer compositions and uses thereof, in particular used in passenger and driver airbag cover applications in vehicles. A method of producing an airbag cover is also described by making a polyolefin composition, and forming a cover. Preferably the cover has a seam having a seam shape, such as “I”, “Y”, “U”, or “H” wherein said cover has a thickness of 1 to about 6 mm.

### BACKGROUND

Current materials used in air bag covers typically include cross-linked thermoplastics (TPV), styrene-ethylene-butylene-styrene (SEBS) composites, styrene-ethylene-butylene (SEB) composites, polyesters or propylene blends. These materials have one or more of the disadvantages of poor flow properties, bad compatibility with other parts and/or paint, being brittle, and requiring oils and extenders.

Some of these above mentioned thermoplastic materials have poor flow properties. Poor flow properties can make these materials very hard to process during the filling stage during injection molding. This results in some design constraints on the molded part. As an example, polyesters typically have poor flow properties, which may make their use limited in complicated mold designs.

Additionally, current air bag cover materials are not always compatible with the other parts in the interior of the vehicle or compatible with paints. This incompatibility may hinder the ability to recycle the parts of the car and match the color of the airbag with the other trim parts in the vehicle. Typically, the other parts of the vehicle interior are made of polypropylene and thermoplastic polyolefins or thermoplastic olefins (TPOs). Using such materials as polyesters or SEBS typically create compatibility problems with these other interior trim parts when it comes to matching paint and recycling.

Previous materials used in airbag covers include filled polypropylene blends. These filled propylene blends (which typically provide enhanced stiffness over unfilled polypropylenes) are disadvantageous because of their brittleness, especially under extreme cold conditions. Filled products are typically more brittle at cold temperatures, have a higher density and do not provide as good weathering as unfilled materials or materials that have additional elastomer added.

Many of these previous materials typically require oils and extenders. Requiring these additional additives increases the process time. These additives may bloom from the surfaces after they are molded, such as while they are in service.

In view of these problems, there is a need in the industry to create a composition useful for making air bag covers for vehicles that does not require oils and extenders, that is not brittle in extreme cold weather and has good weathering properties, and is compatible with interior auto paints.

### SUMMARY OF THE INVENTION

In the composition of the present invention, there are either 2 or 3 polymer components, namely a polypropylene copolymer or a homo polypropylene polymer, and an ethylene octene copolymer. These components are always present and an optional third polymer component—a metallocene elastomer containing ethylene can be present. This product weathers well, does not need oils and extenders, and is durable and flexible in extreme cold and hot conditions (−40° C. to 90° C.). Furthermore, if the third component is present, the air bag cover is easily paintable and can match the interior paint of a vehicle so that repair is possible.

In the broadest sense, the present invention relates to a polymer composition comprising:

a first component having at least one polypropylene copolymer or a homo propylene polymer present in the range of up to about 70% by weight of the polymer composition;

a second component having at least one ethylene/octene copolymer, said second component is present in the range of up to about 85% by weight of the polymer composition; and

optionally, a third component having at least one metallocene elastomer comprising ethylene and a co-monomer, wherein the total weight of all the components comprises 100% by weight of the polymer composition.

Also the present invention also relates to a method of manufacturing an airbag cover comprising:

blending a polymer composition comprising a first component having at least one polypropylene copolymer or a homo propylene polymer in the range of up to about 70% by weight of the polymer composition; a second component having at least one ethylene/octene copolymer in the range of up to about 85% by weight of the polymer composition; and optionally, a third component having at least one metallocene elastomer comprising ethylene and a co-monomer in the range of 0% to about 60% by weight of the polymer composition; and

forming an airbag cover with the polymer composition.

### DETAILED DESCRIPTION

Polymer compositions of the present invention suitable for airbag covers may include three components: a first component containing a polypropylene copolymer or a homo propylene polymer, a second component containing an ethylene/octene copolymer, such as a linear low density polyethylene octene, and optionally a third component containing a metallocene elastomer. The total weight of the polymer composition is 100 wt. %.

The first component, which is always present, has at least one polypropylene copolymer or a homo propylene polymer. This first component may comprise up to 70% by weight of the final polymer composition. Most final polymer compositions contain 5% to 70% by wt. of the polypropylene copolymer or homo propylene polymer, including any intermediate ranges. This first component may be made using a Zigler-Natta catalyst. In an embodiment the propylene copolymer has a high content of ethylene monomer. In one embodiment, the polypropylene copolymer (the first component) has an ethylene-propylene-rubber (EPR) content with about 27% by weight EPR. In another embodiment, the polypropylene copolymer has an ethylene-propylene-rubber (EPR) content with about 18% by weight EPR. The propylene copolymer can have a wide range of EPR (from about 5 to about 50 wt. % of the propylene copolymer may be EPR) to vary the viscosity and thus the flow characteristics of the propylene copolymer. One skilled in the art, with the benefit of this disclosure, can vary the viscosity of the propylene copolymer so as to create different material characteristics. For example, the higher the viscosity of the propylene copolymer in the composition the better the cold impact properties. Suitable propylene copolymers are commercially available from Flint Hills Resources under the product designations AP7710-HS, AP6835-HS and AP7535-HS. In other embodiments, the first component may comprise from about 15% to about 55% by weight of the final polymer composition, including any intermediate ranges between 15 and 55 wt. % of the final polymer composition. One skilled in the art, with the benefit of this disclosure will recognize the other appropriate polypropylene copolymers for use in embodiments of this invention.

The second component, which is also always present, has at least one ethylene/octene copolymer. This second component may comprise up to 85% by weight of the final polymer composition. In an embodiment of the present invention, the ethylene/octene copolymer has a density of about 0.902 g/cm3. Preferably the ethylene/octene copolymer is an LLDPE. This copolymer may be made with a Zigler-Natta catalyst. In suitable embodiments, the octene content is approximately 15 to 25% by weight of the ethylene/octene copolymer which causes the material to be very soft and have very good low temperature impact properties. In another embodiment, the melting point of the copolymer by differential scanning calorimetry (DSC) is typically over 100° C. A commercially available sample of this copolymer is produced by Flint Hills Resources under the grade designation V8401. In preferred embodiments, the second component may comprise from about 15% to about 85% by weight of the final polymer composition, including any intermediate ranges between 15 and 85 wt. %. One skilled in the art, with the benefit of this disclosure will recognize an appropriate ethylene/octene copolymer for use in this invention.

The polymer composition optionally has a third component. The third component, if present, includes a metallocene elastomer which is a copolymer of ethylene with at least one other co-monomer. The other co-monomer may be butene and/or octene. This third component, when present, may comprise up to 60% by weight of the final polymer composition. The third component may be made using a metallocene catalyst. In one embodiment, when octene is used as a co-monomer, the octene content is at least about 20% by weight based upon the total weight of the third component. In another embodiment, when octene is used as a co-monomer, the octene content may be in the range of about 20% to about 60% by weight based upon the total weight of the third component. In embodiments where butene is used as a co-monomer, the crystallinity range of the butene material may be similar to the octene material's crystallinity range. According to an embodiment of the invention, the melt flow rate of the metallocene elastomer component is any melt flow rate in the range of about 0.25 to about 40 grams per 10 minutes using method ASTM D-1238 (2000) at 190° C. and 2.16 kg. According to an embodiment of the invention, the glass transition temperature of the metallocene elastomer component is in the range of −42° C. to −64° C. as determined using differential scanning calorimetry. Commercially available metallocene elastomers may be obtained from Dupont Dow Elastomers LLC of Wilmington, Del. under the tradenames ENGAGE® 8842 polyolefin elastomers, ENGAGE® 8180 polyolefin elastomers, and ENGAGE® 8402 polyolefin elastomers. ENGAGE is a registered mark of the Dupont Dow Elastomers LLC. In preferred embodiments, the third component may comprise from about 20% to about 35% by weight of the final polymer composition, including any intermediate ranges between 20 and 35% by wt. One skilled in the art, with the benefit of this disclosure will recognize appropriate metallocene elastomers for use in this invention.

Embodiments of the present invention may also include additives. Additives may include antioxidants, stabilizers (such as UV stabilizers), and fillers, flame retardants, pigments, and lubricants. Embodiments of the present invention may include a scratch package (a package of desired additives pre-weighed for certain batch sizes). A scratch package may include a polypropylene and siloxane component, a nylon and siloxane component, a fatty acid and/or a coupling agent such as a maleic anhydride grafted polypropylene. Embodiments of the present invention may include a stabilizer system. A stabilizer system may include additives to protect the polymer from degradation. A basic stabilizer package may contain phosphites, phenolics and acid scavengers. Additives for UV protection of the polymer may also be included. Typical scratch packages may be from about 2 to about 12 wt. % add-on, based on the weight of the final polymer composition. In other words the final polymer composition will be 100 wt. % and the scratch package will be an additional amount added-on to the weight of the polymer composition. One skilled in the art will recognize other additives that are suitable for the present invention.

In embodiments of the above invention, the above polymer composition (and additives) may be melt blended, pelletized and then formed (melted and introduced into a mold) into an airbag cover. Melt blending may be done by such equipment as an extruder, a batch mixer or other suitable equipment. The article may be formed by methods known in the art such as injection molding, compression molding, low pressure molding, or another suitable method. In another embodiment, the above components could also be extruded and then thermoformed. In another embodiment, the article of manufacture may be flame treated to improve adhesion. One skilled in the art, with the benefit of this disclosure will recognize other suitable methods to blend, form, and use compositions of this invention.

In another embodiment of this invention, compositions of this material may be used to make injection molded or thermoformed passenger and driver side air bag covers that may or may not have a tear seam. The tear seam can also be formed post molding but it is generally easier and more economical to mold it into the cover. A tear seem may be included to weaken an area so that the cover will fail in a controlled fashion.

Compositions may vary in order to give adequate properties for different applications. These materials have been tested by utilizing prototype and production tools and designs. Airbag covers were designed with 3-4 mm wall thickness with a wide variety of tear seam shapes including “I”, “Y”, “U” and “H” configurations. Various tear seam angles have been used along with different gate locations. Hook & window designs have been used for assembling covers to the module housing. The thickness may be within the range of 1 to about 6 mm in thickness (where the seam may be 1 mm and the remainder maybe thicker). For example, the driver side polymer compositions are usually lower than 50,000 psi flexural modulus and the passenger side polymer compositions are usually lower than 70,000 psi flexural modulus. These tests are typically conducted by using ASTM D790 (2000) test method at a 1.3 mm/min test speed and taking the tangent value. The deployment of the airbags was conducted using an inflator that has a force of 210 Kpa. Overall, the compositions for the cover should be stiff enough to hold its shape and fasten to the interior of the module housing and soft enough to deploy without breakage or brittle fracture that could hinder deployment of the air bag or injure passengers from flying debris. The compositions should operate over a wide temperature range and deploy in a uniform fashion regardless of temperature. Airbag covers using compositions of this invention have been found to perform at a temperature range of −40° C. to 90° C. In order to perform in this wide temperature range, the polymer composition should contain an adequate portion of material with a very low glass transition temperature to allow the material to have a ductile deployment especially at low temperatures and to withstand the higher temperatures, the polymer composition at must prevent excessive sag, significant softening, or melting of the air bag cover.

Advantages of polymer compositions of the present invention may include cost savings over generally more expensive materials currently on the market. Also, the polymer compositions of the present invention may have good paint adhesion characteristics, especially when the third component is present. Additionally, the color of the air bag cover may be molded in color unpainted airbags covers. If the cover is scratched, the pigment is uniformly distributed throughout the thickness of the cover, and the scratch is less likely to be noticed.

### EXAMPLES

### Polymer Composition 1

A polymer composition was made by mixing 20% by weight AP7710-HS (a polypropylene co-polymer supplied by Flint Hills Resources), 50% by weight V8401 (a linear low density polyethylene/octene co-polymer supplied by Flint Hills Resources), and 30% by weight ENGAGE® 8150 polyolefin elastomers (an ethylene/octene co-polymer supplied by Dupont Dow Elastomers LLC).

Polymer Composition 1 was melt blended in a 32 mm twin screw extruder (obtained from Davis-Standard, LLC) and strand cut. Four by six plaques were then molded in an injection molding machine. The samples were painted and tested. These plaques were treated with a 0.2 mil coating of adhesion promoter E75CR910 (commercially available from The Sherman-Williams Company). A 2.0 mil coating was applied including a color base coat (G52HR51R) and a catalyst (V66VM103) (both commercially available from The Sherman-Williams Company). All the coated panels were flame treated and baked for 40 minutes (180 Fahrenheit. No coating adhesion loss was seen performing an initial aggressive adhesion tape test for 30 pulls and after 24 hrs humidity testing at 100° F. at 100% humidity.

### Polymer Composition 2

Nine samples of a polymer composition were made by mixing 20% by weight AP7710-HS (a polypropylene co-polymer supplied by Flint Hills Resources) and 80% by weight V8401 (a linear low density polyethylene/octene co-polymer supplied by Flint Hills Resources). Six samples were flame treated and three of these used an adhesion promoter. A comparison was done comparing the paint adhesion characteristics of these samples. All samples were tested under the same conditions as Polymer Composition 1, Flame treatment along with adhesion promoter are two methods to prepare the surface of the plastic for paint. This shows either method can be used. In the flame treatment, there was no Engage polymer, yet the adhesion results are satisfactory. This was an unexpected result to have the LLDPE have good adhesion without the Engage polymer. It shows it is possible to make an acceptable, paintable, product without the Engage polymer.

| | Initial adhesion | 24 hrs Humidity - adhesion |
|---|---|---|
| | (% loss) | (% loss) |
| | (the lower the better) | (the lower the better) |
| No pre-treatment | | |
| Sample 1 | 20 | 40 |
| Sample 2 | 16 | 40 |
| Sample 3 | 32 | 40 |
| Flame treated | | |
| Samples 4-6 | 0 | 0 |
| Flame treated + | | |
| adhesion promoter | | |
| Samples 7-9 | 0 | 0 |

### Polymer Composition 3

A polymer composition was made by mixing 42.9% by weight AP7710 (a polypropylene co-polymer supplied by Flint Hills Resources) and 19.4% by weight V8401 (a linear low density polyethylene/octene co-polymer supplied by Flint Hills Resources), 26.1% by weight ENGAGE® 8150 polyolefin elastomers (an ethylene/octene co-polymer supplied by Dupont Dow Elastomers LLC), 8.0% by weight DOW CORNING® MB50-321 MASTERBATCH MB50-321 (a siloxane polymer supplied by the Dow Corning Corporation, DOW CORNING is a registered mark of the Dow Corning Corporation), 0.3% by weight LONZEST® GMS (a glyceryl monostearate supplied by Lonza Group Ltd, LONZEST is a registered mark of Lonza Group Ltd), 0.7% by weight erucamide (supplied by Chemtura Corporation), 2% by weight color concentrate, 0.4% by weight CYASORB THT® 7001 light stabilizer (UV protector supplied by Cytec Industries Inc. CYASORB THT is a registered mark of Cytec Industries Inc.), and 0.2% CHIMASSORB® light stabilizer (UV protector supplied by Ciba Specialty Chemicals Inc., CHIMASSORB is a registered mark of Ciba Specialty Chemicals Inc.). Polymer Composition 3 has a scratch package for molded in color (no paint) with a UV package. This product could also be painted. 4×6 samples were beat aged for 3000 hrs at 100 C and they were still ductile at −40° C. and 15 mph on a multi-axial impact machine with a ½″ tup. The UV package retains the color during service but any selection of suitable stabilizer could be used.

### Polymer Composition 4

A polymer composition was made by mixing 44.4% by weight AP7710-HS (a polypropylene co-polymer supplied by Flint Hills Resources) and 20.8% by weight V8401-CS301 (a linear low density polyethylene/octene co-polymer supplied by Flint Hills Resources), 28.2% by weight ENGAGE® 8150 polyolefin elastomers (an ethylene/octene co-polymer supplied by Dupont Dow Elastomers LLC), 4.0% by weight DOW CORNING® MB50-321 MASTERBATCH MB50-321 (a siloxane polymer supplied by the Dow Corning Corporation, DOW CORNING is a registered mark of the Dow Corning Corporation), 2% by weight color concentrate, 0.4% by weight CYASORB THT® 7001 light stabilizer (UV protector supplied by Cytec Industries Inc), and 0.2% by weight TINUVIN® 328 UV absorber (supplied by Ciba Specialty Chemicals Inc., CHIMASSORB is a registered mark of Ciba Specialty Chemicals Inc.). From this composition was created a molded in color (MIC) passenger side airbag cover. This Polymer Composition was found to be acceptable for airbag covers.

### Polymer Composition 5

A polymer composition was made by mixing 48.4% by weight AP7710-HS (a polypropylene co-polymer supplied by Huntsman Corporation) and 19.8% by weight V840′-CS301 (a linear low density polyethylene/octene co-polymer supplied by Flint Hills Resources), 29.2% by weight ENGAGE® 8150 polyolefin elastomers (an ethylene/octene co-polymer supplied by Dupont Dow Elastomers LLC), 2% by weight color concentrate, 0.4% by weight CYASORB THT® 7001 light stabilizer (UV protector supplied by Cytec Industries Inc), and 0.2% by weight TINUVIN® 328 UV absorber (supplied by Ciba Specialty Chemicals Inc., CHIMASSORB is a registered mark of Ciba Specialty Chemicals Inc.). This composition was molded into a paintable passenger side airbag cover. This Polymer composition was also found to be acceptable

Thus it is apparent that there has been provided, in accordance with the invention, a composition and a method that fully satisfies the objects, aims, and advantages set forth above. While the invention has been described in conjuncture with specific embodiments thereof, it is evident that many alternatives, modifications, and variations will be apparent to those skilled in the art in light of the foregoing description. Accordingly, it is intended to embrace all such alternatives, modifications and variations as fall within the spirit and broad scope of the invention.

What is claimed is:

1. A polymer composition comprising:
a first component having at least one polypropylene copolymer or homo propylene polymer present in the range of up to about 70% by weight of the polymer composition;
a second component having at least one ethylene/octene copolymer present in the range of up to about 85% by weight of the polymer composition; and
optionally, a third component having at least one metallocene elastomer comprising ethylene and a co-monomer.

2. A polymer composition of claim 1, wherein the third component when present is present in the range of up to about 60% by weight of the polymer composition.

3. A polymer composition of claim 1, wherein the first component is present in the range of 5% to 70% by weight of the polymer composition.

4. A polymer composition of claim 1, wherein the first component includes an ethylene-propylene-rubber content from about 5 to about 50 wt. % of said first component

5. A polymer composition of claim 1 wherein the first component is present in the range of about 15% to about 55% by weight of the polymer composition.

6. A polymer composition of claim 1, wherein said second component has a density of about 0.9 g/cm³.

7. A polymer composition of claim 1, wherein said second component has an octene content of 15 to 25 wt. %.

8. A polymer composition of claim 1, wherein said second component comprises 15 to 85% by wt. of said polymer composition.

9. A polymer composition according to claim 1 wherein the co-monomer of the third component comprises octene or butene.

10. A polymer composition according to claim 9, wherein the octene content of the third component is in the range of about 20% to about 60% by weight based upon the total weight of the third component.

11. A polymer composition according to claim 1, wherein said ethylene of the second component comprises a linear low density polyethylene.

12. A polymer composition according to claim 1, wherein the co-monomer of the third component comprises butene.

13. A polymer composition according to claim 1, wherein the third component has a glass transition temperature in the range of about −42° C. to about −64° C. as determined using differential scanning calorimetry using test method outlined in ASTM D 3418 (2000).

14. A polymer composition according to claim 1, wherein the third component has a melt flow rate in the range of between about 0.25 to about 40 grams per 10 minutes using test method ASTM D 1238 (2000) at a temperature of 190° C. and 2.16 kg weight.

15. A method of manufacturing an airbag cover comprising:
blending a polymer composition comprising a first component having at least one polypropylene copolymer or a homo propylene polymer in the range of up to about 70% by weight of the polymer composition; a second component having at least one ethyleneoctene copolymer in the range of up to about 85% by weight of the polymer composition; and optionally, a third component having at least one metallocene elastomer comprising ethylene and a co-monomer in the range of 0% to about 60% by weight of the polymer composition; and
forming an airbag cover with the polymer composition.

16. The method of claim 15 wherein the ethylene/octene copolymer of the second component comprises a linear low density polyethylene monomer.

17. The method of claim 15 further comprising adding a scratch package to the polymer composition.

18. The method of claim 15 further comprising adding a stabilizer system to the polymer composition.

19. The method of claim 15 wherein forming the airbag cover further comprises forming a seam on the airbag cover.

20. The method of claim 19, wherein said seam is “I”, “Y”, “U”, or “H” shaped.

21. The method of claim 15, wherein said cover has a thickness of 1 to about 6 mm.
